(19) United States
(12) Patent Application Publication
(10) Pub. No.: US 2024/0248234 A1
(43) Pub. Date: Jul. 25, 2024

(54) PROCESSES FOR PREDICTING AND ADDRESSING RETROGRADE CONDENSATE LIQUID DROPOUT IN A SUBSURFACE FORMATION

(71) Applicant: Saudi Arabian Oil Company, Dhahran (SA)

(72) Inventors: Ammar Agnia Khalifa, Dhahran (SA); Habib Alfian Tafsiri, Dhahran (SA); Abdulrahman Nutaifi, Dhahran (SA); Abdulrahman Huthlul, Dhahran (SA)

(73) Assignee: Saudi Arabian Oil Company, Dhahran (SA)

(21) Appl. No.: 18/157,902

(22) Filed: Jan. 23, 2023

(51) Int. Cl. G01V 99/00; E21B 43/16; E21B 43/24; E21B 47/07; E21B 49/08

(52) U.S. Cl. CPC G01V 99/005; E21B 43/168; E21B 43/24; E21B 47/07; E21B 49/088

(57) ABSTRACT

A process for predicting and addressing retrograde liquid condensate dropout (LDO) in a hydrocarbon subsurface formation may include determining a maximum retrograde condensate liquid dropout (LDOₘₐₓ) for the subsurface formation; generating a normalized model of retrograde condensate liquid dropout versus subsurface formation pressure according to an equation with formula:

$$L {DO}_{nrm} = L {DO}_{max} * \frac{( {e}^{( - 1 * {f}_{Bell} * {( {P}_{nrm} - {P}_{nrmPeak} )}^{2} )} )}{( 1 {0}^{- 7} * {Z}_{C 7 +} * {e}^{{f}_{H u b b} * {P}_{n r m}} ) + 1} ;$$

inputting a normalized pressure (Pₙᵣₘ) into the model based on the pressure of the subsurface formation; and de-normalizing the LDOₙᵣₘ according to the formula: LDO=LDOₙᵣₘ*LDOₘₐₓ, thereby generating a predicted condensate liquid dropout within the subsurface formation.

### TECHNICAL FIELD

Embodiments herein relate to methods for addressing the phenomena of condensate precipitation or condensate blockage in a subsurface formation, and more specifically, to processes for predicting and addressing retrograde condensate liquid dropout.

### BACKGROUND

The discovery and extraction of hydrocarbons, such as oil or natural gas, from subsurface formations, may be impeded for a variety of reasons, which may also be dependent on the category of hydrocarbon reservoir the extraction is taken from. For example, a retrograde condensate gas reservoir exists initially as a single-phase fluid (gaseous with dissolved condensate), which changes towards two phases (gas and at least some precipitated condensate liquid) in the reservoir as the reservoir pressure declines below the dew point pressure of the gas condensate reservoir. The condensate, if produced to the surface, can significantly improve the economics of a given gas field development due to the extra cash flow that it provides.

However, precipitated condensates can often accumulate within the subsurface formation and wellbore, such as within the pore space that used to be carrying a single-phase gas alone. That portion of precipitated condensates may be referred to generally as the “Condensate Saturation.” As further reservoir pressure depletion occurs, the condensate saturation increases and the passage to gas flow within the pores further shrinks. This may ultimately lead to a decreased rate of production of gas and condensate from the subsurface formation and the wellbore as compared to the expected rate of production. This may be commonly referred to as condensate blockage, or less commonly as condensate banking. In more severe cases of condensate blockage, the liquid condensate may block further production of hydrocarbons from the subsurface formation as the wellbore loads with liquid condensate.

### SUMMARY

In the above instances, methods for mitigating and/or removing condensate blockage in the subsurface formation can be utilized to improve hydrocarbon production. Conventional techniques include dry gas injection, huff-and-puff, chemical solutions injection, hydraulic fracturing, artificial lifting, or combinations thereof. In theory, the optimal application of each technique depends on subsurface formation temperature, pressure, depth, net pay, permeability, residual oil and water saturations, porosity, hydrocarbon composition, as well as other economic factors. For example, where the condensate yield is high, measures can be taken to maintain the reservoir pressure above the dew point so that each unit of gas quantity produced will contain its maximum condensate yield and no liquid will deposit in the reservoir, for example, in gas injection. If condensate yield is low, pressure drawdown may be utilized wisely in such way that every pressure drop unit is utilized for hydrocarbons extraction, for example in hydraulic fracturing or drilling configurations designed to maximize reservoir contact.

However, traditional strategies to mitigate condensate deposition and blockage are usually undertaken either before production of hydrocarbons initially occurs or after a reduction in production of hydrocarbons is observed. Upon observing a reduction in production or performance, the wellbore may already be loading with dropped-out (precipitated) liquid condensate and the subsurface formation may be approaching a condensate blockage situation. Accordingly, desired are processes of predicting retrograde liquid condensate dropout in a subsurface formation before the retrograde liquid condensate dropout actually occurs. Moreover, prediction techniques are desired that do not require monetary investment and time for detailed laboratory experiments of produced hydrocarbon samples from the subsurface formation.

Accordingly, processes herein allow prediction of retrograde liquid condensate dropout in a subsurface formation with the aforementioned benefits. Particularly, processes herein allow the prediction of retrograde liquid condensate dropout at a given subsurface formation reservoir pressure with the input of at least three easily obtainable parameters: subsurface formation temperature, dew point pressure for the hydrocarbons of the subsurface formation, and a mole percentage of C₇₊ hydrocarbons (fractions including heptane and greater) within the hydrocarbons of the subsurface formation.

Further, the processes herein may also allow prediction of the pressure at which maximum retrograde condensate liquid dropout occurs, thereby allowing traditional methods of removing condensate to be applied proactively instead of reactively. This proactivity may allow methods of removing condensate to be applied as subsurface formation pressure approaches the predicted maximum liquid dropout and may thereby reduce the amount of energy input needed to suspend produce condensates with other hydrocarbons.

In accordance with one embodiment discussed herein, a process for predicting retrograde liquid condensate dropout in a hydrocarbon containing subsurface formation may include determining a maximum retrograde condensate liquid dropout (LDOₘₐₓ) for the subsurface formation; generating a normalized model of retrograde condensate liquid dropout versus subsurface formation pressure according to an equation with formula:

$$L {DO}_{nrm} = L {DO}_{max} * \frac{( {e}^{( - 1 * {f}_{Bell} * {( {P}_{nrm} - {P}_{nrmPeak} )}^{2} )} )}{( 1 {0}^{- 7} * {Z}_{C 7 +} * {e}^{{f}_{H u b b} * {P}_{n r m}} ) + 1} ;$$

inputting a normalized pressure (Pₙᵣₘ) into the model based on the pressure of the subsurface formation; and de-normalizing the LDOₙᵣₘ according to the formula: LDO=LDOₙᵣₘ*LDOₘₐₓ, thereby generating a predicted condensate liquid dropout within the subsurface formation.

In accordance with another embodiment discussed herein, a process for predicting and addressing retrograde liquid condensate dropout in a hydrocarbon containing subsurface formation may include generating the predicted condensate liquid dropout within the subsurface formation according to the previous embodiment. The process may further include predicting (i) an expected injection pressure of the gas necessary to maintain the pressure of the subsurface formation above the subsurface formation dew point pressure or (ii) an expected injection pressure of the gas into the wellbore necessary to suspend and produce liquid condensate of the hydrocarbons of the subsurface formation in the wellbore, at the predicted condensate liquid dropout; communicating the expected injection pressure to a compressor unit, the compressor unit configured to inject the gas at the injection pressure into the wellbore of the subsurface formation; and adjusting the injection pressure of the gas into the wellbore at the compressor unit to the expected injection pressure to address the retrograde liquid condensate dropout in the subsurface formation.

In accordance with yet another embodiment discussed herein, a process for predicting and addressing retrograde liquid condensate dropout in a hydrocarbon containing subsurface formation may include generating the predicted condensate liquid dropout within the subsurface formation according to the above embodiments. The process may further include predicting (i) an expected amount of the liquid condensate dissolving solution necessary to dissolve liquid condensate of the hydrocarbons of the subsurface formation at the predicted condensate liquid dropout or (ii) an expected injection rate of the liquid condensate dissolving solution necessary to dissolve the liquid condensate of the hydrocarbons of the subsurface formation at the predicted condensate liquid dropout; communicating the expected amount of the liquid condensate dissolving solution or the expected injection rate of the liquid condensate dissolving solution to a pump, the pump configured to inject the liquid condensate dissolving solution into the wellbore of the subsurface formation; and injecting the expected amount of the liquid condensate dissolving solution or the expected injection rate of the liquid condensate dissolving solution into the wellbore of the subsurface formation to address retrograde liquid condensate dropout (LDO) in the subsurface formation.

In accordance with yet another embodiment discussed herein, a system for predicting and addressing retrograde liquid condensate dropout in a hydrocarbon containing subsurface formation may include a compressor unit configured to inject a gas at an injection pressure into the wellbore of the subsurface formation; and a computer processor communicatively coupled to the compressor unit and operable to execute a method with the compressor unit. The method the computer process may execute may include generating the predicted condensate liquid dropout within the subsurface formation according to the above embodiments. The method may further include predicting (i) an expected injection pressure of the gas necessary to maintain the pressure of the subsurface formation above the subsurface formation dew point pressure or (ii) an expected injection pressure of the gas into the wellbore necessary to suspend and produce liquid condensate of the hydrocarbons of the subsurface formation in the wellbore, at the predicted condensate liquid dropout; communicating the expected injection pressure to the compressor unit; and adjusting the injection pressure of the gas into the wellbore to the expected injection pressure to address the retrograde liquid condensate dropout in the subsurface formation.

In accordance with yet another embodiment discussed herein, a system for predicting and addressing retrograde liquid condensate dropout in a hydrocarbon containing subsurface formation may include a pump configured to inject a liquid condensate dissolving solution into a wellbore of the subsurface formation; and a computer processor communicatively coupled to the pump and operable to execute a method with the pump. The method the computer process may execute may include generating the predicted condensate liquid dropout within the subsurface formation according to the above embodiments. The method may further include predicting (i) an expected amount of the liquid condensate dissolving solution necessary to dissolve liquid condensate of the hydrocarbons of the subsurface formation at the predicted condensate liquid dropout or (ii) an expected injection rate of the liquid condensate dissolving solution necessary to dissolve the liquid condensate of the hydrocarbons of the subsurface formation at the predicted condensate liquid dropout; communicating the expected amount of liquid condensate dissolving solution or the expected injection rate of liquid condensate dissolving solution to the pump, and injecting the expected amount of the liquid condensate dissolving solution or the expected injection rate of the liquid condensate dissolving solution into the wellbore of the subsurface formation to address the retrograde liquid condensate dropout in the subsurface formation.

Additional features and advantages of the described embodiments will be set forth in the detailed description, which follows, and in part will be readily apparent to those skilled in the art from that description or recognized by practicing the described embodiments, including the detailed description, which follows, as well as the claims.

### BRIEF DESCRIPTION OF THE DRAWINGS

The following detailed description of specific embodiments herein can be best understood when read in conjunction with the following drawings in which:

Figure (FIG. 1A illustrates a graph of pressure vs. liquid dropout measurements for a hydrocarbon sample from a retrograde condensate reservoir.

FIG. 1B illustrates a graph of normalized pressure vs. normalized liquid dropout on vertical and horizontal scales of 0 to 1 for the graph of FIG. 1, as well as a hybrid model of Logistic-Hubbert and Bell curves fit to the same.

FIG. 2A illustrates the relationship of Z_{C7+} to LDOₘₐₓ for the model.

FIG. 2B illustrates the correlation between LDOₘₐₓ determined by the model and LDOₘₐₓ determined by laboratory calculations.

FIG. 3A illustrates the relationship of Z_{C7+} to Pₙᵣₘmax for the model.

FIG. 3B illustrates the correlation between Pₙᵣₘmax determined by the model and Pₙᵣₘmax determined by laboratory calculations.

FIG. 4A illustrates the relationship of Z_{C7+} to the Hubbert scaling factor for the model.

FIG. 4B illustrates the correlation between the Hubbert scaling factor determined by the model and the Hubbert scaling factor determined by laboratory calculations.

FIG. 5A illustrates the relationship of Z_{C7+} to the bell curve scaling factor for the model.

FIG. 5B illustrates the correlation between the bell curve scaling factor determined by the model and the bell curve scaling factor determined by laboratory calculations.

FIGS. 6A-6C illustrate blind testing of the model vs. known retrograde condensate reservoir data sets.

FIG. 7 illustrates the correlation between the liquid dropout determined by the model and the liquid dropout determined by laboratory calculations for a large data set of various retrograde condensate reservoirs.

### DETAILED DESCRIPTION

As used herein, the terms “condensate,” “liquid condensate,” or “retrograde liquid condensate” refer to a liquid hydrocarbon phase that generally occurs in association with natural gas. The American Petroleum Institute (API) gravity of condensate is typically greater than 500. API gravity is a measure of a substances relative density towards water and is measured using a hydrometer. For example, for an API gravity greater than 10°, the substance will be less dense and float on water. Less than 10° sinks. The condensate's presence as a liquid phase depends on temperature and pressure conditions in the subsurface formation allowing condensation of liquid from vapor. This may be illustrated for example in a dual-phase pressure vs. temperature envelope, as is known in the art.

As used herein, the term “condensate blockage” refers to a relative permeability effect where condensate drops out of the vapor phase of produced hydrocarbons around the wellbore when the pressure drops to less than the dew point in response to drawdown or depletion. Blockage may occur when the condensate accumulates in pore throats transporting the produced hydrocarbons, thereby reducing the relative permeability to the produced hydrocarbons through the same. Gas production rate may be severely reduced by the permeability reduction. As used herein, “condensate blockage” may also refer to the components of the condensate blockage, rather than its effect. In a similar manner, “retrograde condensate liquid dropout” or “LDO,” as used herein, may refer to the percentage of condensate that will drop out of the vapor phase as compared to the total volume of hydrocarbons above the dew point pressure. For example, a LDO of 8% may mean that 8% of the total hydrocarbons will be liquid condensate at a given subsurface formation pressure.

The term “dew point” refers to the pressure at which the first infinitesimal droplet of liquid, such as liquid condensate, comes out of a vapor phase of gas.

As used herein, the terms “downhole” and “uphole” may refer to a position within a wellbore relative to the surface, with uphole indicating direction or position closer to the surface and downhole referring to direction or position farther away from the surface.

As used herein, a “subsurface formation” may refer to a body of rock that is sufficiently distinctive and continuous from the surrounding rock bodies that the body of the rock may be mapped as a distinct entity. A subsurface formation is, therefore, sufficiently homogenous to form a single identifiable unit containing similar properties throughout the subsurface formation, including, but not limited to, porosity and permeability.

As used herein, “wellbore,” may refer to a drilled hole or borehole extending from the surface of the Earth down to the subsurface formation, including the openhole or uncased portion. The wellbore may form a pathway capable of permitting fluids to traverse between the surface and the subsurface formation. The wellbore may include at least a portion of a fluid conduit that links the interior of the wellbore to the surface. The fluid conduit connecting the interior of the wellbore to the surface may be capable of permitting regulated fluid flow from the interior of the wellbore to the surface and may permit access between equipment on the surface and the interior of the wellbore.

As used herein, a “wellbore wall” may refer to the interface through which fluid may transition between the subsurface formation and the interior of the wellbore. The wellbore wall may be unlined (that is, bare rock or formation) to permit such interaction with the subsurface formation or lined, such as by a tubular string, so as to prevent such interactions. The wellbore wall may also define the void volume of the wellbore.

As previously stated, embodiments herein are directed to processes of predicting retrograde liquid condensate dropout (LDO) in a subsurface formation that includes hydrocarbons. Embodiments herein are also directed to processes of predicting and addressing retrograde liquid condensate dropout in a subsurface formation that includes hydrocarbons.

A process for predicting retrograde condensate liquid dropout in a subsurface formation comprising hydrocarbons may include determining a subsurface formation temperature (T_{R}) in degrees Fahrenheit (° F.), determining a dew point pressure (P_{dcw}) in pounds per square inch (psi) for the hydrocarbons of the subsurface formation, and determining a mole percentage (1-100%) of C₇₊ hydrocarbons (Z_{C7+}) within the hydrocarbons of the subsurface formation. The process may also include determining a maximum retrograde condensate liquid dropout (LDOₘₐₓ) for the subsurface formation based on the T_{R}, Pd_{ew}, and Z_{C7+}.

In embodiments, the dew point pressure may be determined using laboratory experiment utilizing optical detection devices, as may be understood in the art. The dew point pressure may also be determined using one or more correlations, as may be understood in the art, such as from Nemeth et al., A Correlation of Dewpoint Pressure With Fluid Composition and Temperature, Society of Petroleum Engineers Journal. (1 Jun. 1967).

In embodiments, determining the mole percentage of C₇₊ hydrocarbon fractions (Z_{C7+}) within the hydrocarbons of the subsurface formation may include analyzing a sample of the hydrocarbons of the subsurface formation using gas chromatography-mass spectrometry, as may be understood in the art. The mole percentage of C₇₊ hydrocarbon fractions may also be determined using one or more correlations, as may be understood in the art, such as from Ovalle A et. al., Tools To Manage Gas/Condensate Reservoirs; Novel Fluid-Property Correlations on The Basis of Commonly Available Field Data. SPE Reservoir Evaluation & Engineering. December 2007. pp. 687-694.

In embodiments, the subsurface formation temperature may be determined from measurements taken directly from downhole temperature gauges. These measurements may be taken during the drilling of the subsurface formation or during testing operations for the wellbore associated with the subsurface formation.

As previously discussed, the process may further include determining a maximum retrograde condensate liquid dropout (LDOₘₐₓ) for the subsurface formation, the LDOₘₐₓ being a function of one or more of the T_{R}, the P_{dew}, and the Z_{C7+}. The process may further yet include generating a normalized model of retrograde condensate liquid dropout versus observed subsurface formation pressure according to an Equation I with formula:

$$L {DO}_{nrm} = L {DO}_{max} * \frac{( {e}^{( - 1 * {f}_{Bell} * {( {P}_{nrm} - {P}_{nrmPeak} )}^{2} )} )}{( 1 {0}^{- 7} * {Z}_{C 7 +} * {e}^{{f}_{H u b b} * {P}_{n r m}} ) + 1} . \qquad ( I )$$

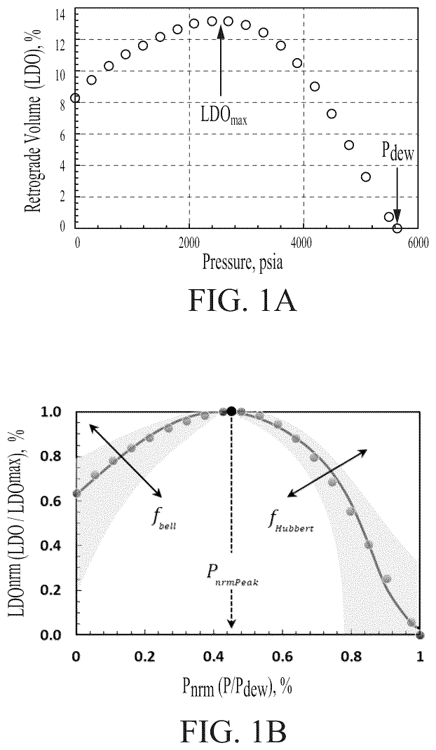

The normalized model is illustrated for example in FIG. 1B. The process may also further include inputting a first normalized pressure (Pₙᵣₘ) into the model based on a first observed pressure of the subsurface formation, thereby generating a normalized predicted condensate liquid dropout within the subsurface formation. Pₙᵣₘ may be a function of the dew point pressure and an observed pressure of the subsurface formation according to an Equation II with formula:

$${P}_{nrm} = \frac{{P}_{R}}{{P}_{d e w}} . \qquad ( II )$$

As described herein, “e” generally denotes the exponential constant, “f_{Hubb}” denotes a Hubbert curve scaling factor; “P_{R}” denotes the observed subsurface formation pressure; “f_{Bell}” denotes a bell curve scaling factor; and “P_{nrmPeak}” denotes a normalized pressure of the subsurface formation at which LDOₘₐₓ occurs. Together, P_{nrmPeak}, f_{Bell}, and f_{Hubbert} may control the dimensions of the curve, as shown by the shaded portions of FIG. 1B and explained in further detail infra.

As previously stated, LDOₘₐₓ may be a function of one or more of the T_{R}, the P_{dew}, and the Z_{C7+}. For example, and in embodiments, the equation used to determine LDOₘₐₓ may be dependent on the mole percentage of C₇₊ hydrocarbons within the hydrocarbons of the subsurface formation. For subsurface formations with hydrocarbons having a Z_{C7+} less than 5 mole percent, LDOₘₐₓ may be determined according to an Equation III with formula:

$$L {DO}_{max} = {x}_{1} * {( {Z}_{C 7 +} )}^{{x}_{2}} . \qquad ( III )$$

As described herein, “x₁” may denote a constant equal to 0.306555305. x₁ may also denote a constant of from 0.15 to 0.45. Also as described herein, “x₂” may denote a constant equal to 1.950724556. x₂ may also denote a constant of from 1.8 to 2.1.

However, for subsurface formations with hydrocarbon having a Z_{C7+} greater than or equal to 5 mole percent, LDOₘₐₓ may be determined according to an Equation IV with formula:

$$L {DO}_{max} = {x}_{3} - ( {x}_{4} * \frac{Ln ( {P}_{d e w} )}{{e}^{{Z}_{C 7 +}}} ) - ( {x}_{5} * Ln ( {T}_{R} ) ) . \qquad ( IV )$$

As described herein, “Ln” generally denotes the natural logarithm. Also as described herein, “x₃” may denote a constant equal to 410.2316146. x₃ may also denote a constant of from 410 to 560. Also as described herein, “x₄” may denote a constant equal to 35.78709971. x₄ may also denote a constant of from 35 to 45. Also as described herein, “x₅” may denote a constant equal to 19.00290983. x₅ may also denote a constant of from 18 to 30.

Without being limited by theory, this differentiating treatment of LDOₘₐₓ around 5 mole percent Z_{C7+} may be due to the observation that below that threshold the liquid condensate dropout is very small and its dependence deteriorates with other parameters. Further, the laboratory measurement of liquid content at low Z_{C7+} holds considerable uncertainty due to the limited liquid yield, upon which the LDOₘₐₓ function is based on. Any volume of liquid content precipitated may form a liquid film on the experimental cell walls or be trapped by surface tension, potentially introducing error into the measurement. Accordingly, the LDOₘₐₓ function has dual equations to account for this behavior and potential error during experimental measurement.

A Bell curve is a symmetric logistic derivative distribution curve. In Equation I, the Bell curve scaling factor may control the model's width and plateau, that is, it may control the area underneath the model's curve. In embodiments, the Bell curve scaling factor may be determined according to an Equation V with formula:

$${f}_{B e l l} = {Z}_{C 7 +} * \frac{{x}_{6}}{{x}_{7} + {( L {DO}_{max} )}^{{x}_{8}}} . \qquad ( V )$$

As described herein, “x₆” may denote a constant equal to 15, “x₇” may denote a constant equal to 8.8, and “x₈” may denote a constant equal to 1.4. x₆ may also denote a constant of from 10 to 20. x₇ may also denote a constant of from 5 to 20. x₈ may also denote a constant of from 1.1 to 1.7.

A Hubbert curve is a subcategory of bell curves commonly used to approximate the production rate of a resource over time, such as oil and gas reservoirs. In Equation 1, the Hubbert curve scaling factor may control the model's tail values, that is, the shape of the ends of the curves of the model. In embodiments, the Hubbert curve scaling factor may be determined according to an Equation VI with formula:

$${f}_{H u b b} = ( - {x}_{9} * L {DO}_{max} ) + {x}_{10} . \qquad ( VI )$$

As described herein, “x₉” may denote a constant equal to 0.2047 and “x₁₀” may denote a constant equal to 24.239. x₉ may also denote a constant of from 0.15 to 0.25. x₁₀ may also denote a constant of from 22 to 26.

In Equation I, the normalized peak pressure (P_{nrmPeak}) may be determined according to an Equation VII with formula:

$${P}_{n r m P e a k} = {x}_{11} + ( {x}_{12} * {( {Z}_{C 7 +} )}^{{x}_{13}} * {( L {DO}_{max} )}^{{x}_{14}} * {( \frac{1}{Ln ( {P}_{d e w} )} )}^{{x}_{15}} ) - ( {x}_{16} * {( \frac{1}{Ln ( {T}_{R} )} )}^{{x}_{17}} ) . \qquad ( VII )$$

As described herein, “x₁₁” may denote a constant equal to 1.1368; “x₁₂” may denote a constant equal to 0.0051; “x₁₃” may denote a constant equal to 0.629; “x₁₄” may denote a constant equal to 0.959; “x₁₅” may denote a constant equal to 0.0826; “x₁₆” may denote a constant equal to 4.354; and “x₁₇” may denote a constant equal to 0.907. x₁₁ may also denote a constant of from 1.0 to 1.4. x₁₂ may also denote a constant of from 0.002 to 0.008. x₁₃ may also denote a constant of from 0.3 to 0.9. x₁₄ may also denote a constant of from 0.7 to 1.2. x₁₅ may also denote a constant of from 0.05 to 0.2. x₁₆ may also denote a constant of from 4 to 4.5. x₁₇ may also denote a constant of from 0.8 to 1.0.

As previously stated, embodiments herein also include processes for predicting and addressing retrograde liquid condensate dropout. These processes may include any of the processes mentioned supra. However, the processes for predicting and addressing retrograde liquid condensate dropout may also include further steps as described infra. For example, and in embodiments, the processes herein may be used to improve hydrocarbon recovery systems including but not limited to: ‘artificial lift operations’, well stimulation, and injections of dry gas or liquid condensate dissolving solutions. As would be recognized in the art, proactive methods of reducing or preventing condensate blockage are preferred, as liquid condensate becomes increasingly difficult to remove and resume normal hydrocarbon production as the liquid condensate continues to drop out of the gaseous hydrocarbons.

Without being limited by theory, ‘Artificial lift’ may aim to increase the natural lift of produced hydrocarbon gases within a hydrocarbon production operations such as ‘gas lift’ and ‘plunger lift’. Particularly, treatment using gas lift typically involves the injection of gas into a wellbore of the subsurface formation. The gas becomes entrained in the hydrocarbons of the wellbore and subsurface formation, thereby decreasing the amount of energy required to ‘lift’ the hydrocarbons and the liquid condensate to the surface (increasing the natural lift). Gas may include hydrocarbon gases such as methane, or nonhydrocarbon gases like nitrogen or carbon dioxide. Gas lift may also be combined with a cyclic intervention approach, such as by combining with periodic liquid condensate dissolving solutions, as discussed infra. Produced hydrocarbon gases from the subsurface formation itself such as methane may also be recycled to be used as additional injection gas, reducing the logistical challenges for procurement, transportation, and on-site handling of gases.

Additionally or alternatively, ‘gas lift’ may also aim to maintain pressure (by reducing the pressure drawdown required to flow) in proximity of the wellbore greater than the dew-point pressure of the subsurface formation, thereby preventing liquid condensate drop out from the hydrocarbons which may be in the gaseous phase. Gas lift in this manner may otherwise be consistent with those points mentioned supra.

Accordingly, without being limited by theory, the use of a prediction method for retrograde condensate liquid dropout may thereby allow proactive adjustment of the amount of injected gas in gas lift operations, to limit or otherwise prevent the precipitation of liquid condensates in the wellbore, hence on the longer term delaying the pressure depletion of the subsurface formation below the dew point pressure. For example, and in embodiments, the processes hereinbefore may additionally include predicting an expected injection pressure of the gas necessary for lifting, i.e., an expected injection pressure necessary to maintain the pressure of the subsurface formation above the subsurface formation dew point pressure and thereby the liquid condensates in the gas phase. The process may also subsequently include injecting the gas at the expected injection pressure. The injection of the gas into the wellbore may occur through the use of a compressor unit.

Alternatively or additionally, ‘dry gas injection’ the process may include injecting dry gas into the subsurface formation at a first injection pressure. Dry gas may include hydrocarbon gases such as methane, or nonhydrocarbon gases like nitrogen or carbon dioxide. ‘Dry gas injection’ may aim to increase the reservoir pressure above the dew point and strip out the liquid condensate, enriching the dry gas and bringing the condensate back to the gaseous state. Dry gas injection may also aim to create a miscibility contact to move the liquid condensate. The process may also include predicting an expected injection pressure of hydrocarbon gas necessary to suspend and produce the hydrocarbons, including the liquid condensates, of the subsurface formation at the predicted condensate liquid dropout, and adjusting the first injection pressure to the expected injection pressure. In embodiments, the first injection pressure may be adjusted to the expected injection pressure by adjusting a pressure of the compressor.

As one of ordinary skill in the art would understand, the predicted injection pressure of the gas necessary to maintain the pressure above the dew point or at a level sufficient to suspend and produce the hydrocarbons through the compressor unit may generally be determined by using one or more correlations or commercially available simulation programs. As one of ordinary skill in the art would also understand, the one or more correlations or commercially available simulation programs may themselves be dependent on the Z_{C7+}, P_{dew}, subsurface formation pressure, subsurface formation temperature, depth of the subsurface formation, dimensions of the wellbore, and composition of the injected gas.

Without being limited by theory, the injection of liquid condensate dissolving solutions is a category of cyclic interventions for retrograde liquid condensate blockage wherein a chemical solution may be injected into a subsurface formation containing gaseous hydrocarbons and liquid condensate. The liquid condensate dissolving solution may generally increase the solubility of the liquid condensates within the gaseous hydrocarbons, thereby reducing the interfacial tension and potentially the dew-point pressure for liquid condensate drop out. Liquid condensate dissolving solutions herein may include methanol, supercritical water, steam, carbon dioxide, supercritical carbon dioxide, or combinations thereof.

For example, and in embodiments, the process may include predicting an expected amount of liquid condensate dissolving solution necessary to dissolve liquid condensate of the hydrocarbons of the subsurface formation at the predicted condensate liquid dropout. The process may also including injecting the expected amount of the liquid condensate dissolving solution necessary to dissolve the liquid condensate in the hydrocarbons.

Similar to that for gas lift, as one of ordinary skill in the art would understand, the expected amount of liquid condensate dissolving solution necessary to dissolve liquid condensate of the hydrocarbons of the subsurface formation may generally be determined by using one or more correlations or commercially available simulation programs. As one of ordinary skill in the art would also understand, the one or more correlations or commercially available simulation programs may themselves be dependent on the Z_{C7+}, P_{dew}, subsurface formation pressure, subsurface formation temperature, depth of the subsurface formation, dimensions of the wellbore, and composition of the liquid condensate dissolving solution.

In embodiments, the previously discussed processes and application of the model may be repeated as hydrocarbon are produced from the subsurface formation and the pressure of the subsurface formation is observed to decrease. For example, the process may further include observing a decrease in the pressure of the subsurface formation. The process may then include inputting a second normalized pressure (Pₙᵣₘ) into the model based on the pressure of the subsurface formation, thereby generating a second normalized predicted condensate liquid dropout (second LDOₙᵣₘ) within the subsurface formation. The process may then include de-normalizing the second LDOₙₒᵣₘ according to the formula: LDO=LDOₙₒᵣₘ*LDOₘₐₓ, thereby generating a second predicted condensate liquid dropout within the subsurface formation. The process may then include at least one of: predicting a second expected injection pressure of the gas necessary to suspend and produce the hydrocarbons of the subsurface formation at the second predicted condensate liquid dropout; and adjusting the injection pressure to the second expected injection rate; or predicting an expected amount of liquid condensate dissolving solution necessary to dissolve liquid condensate of the hydrocarbons of the subsurface formation at the second predicted condensate liquid dropout; and injecting the expected amount of the liquid condensate dissolving solution necessary to dissolve the hydrocarbons at the second predicted condensate liquid dropout.

As previously stated, embodiments herein also include systems for predicting and addressing retrograde liquid condensate dropout. These systems may be operable to conduct any of the processes mentioned hereinbefore. For example, and in embodiments, a system for predicting and addressing retrograde liquid condensate dropout may include the subsurface formation, a compressor unit, and a computer processor. The subsurface formation may include the hydrocarbons as well as an associated wellbore. The wellbore may be operable may provide a fluid pathway from the subsurface formation to the surface, wherein the hydrocarbons from the subsurface formation may be produced to the surface. The compressor unit may be configured to inject the gas into at least the wellbore. In other words, the compressor unit may be fluidly connected to the subsurface formation and the associated wellbore. The gas (injected gas) may include carbon dioxide or a hydrocarbon gas such as methane, as hereinbefore discussed. In this manner, the compressor unit may be operable to conduct gas lift operations as hereinbefore discussed.

In embodiments, the computer processor may be communicatively coupled to the compressor unit. The computer processor may also be operable to execute a method with the compressor unit. The method may include determining the LDOₘₐₓ for the subsurface formation, generating the normalized model of retrograde condensate liquid dropout versus subsurface formation pressure, inputting the normalized pressure into the model based on the pressure of the subsurface formation, thereby predicting the LDOₙᵣₘ within the subsurface formation, and de-normalizing the LDOₙₒᵣₘ, thereby generating the predicted condensate liquid dropout within the subsurface formation. In other words, the computer processor may be operable to conduct any of the processes hereinbefore.

In embodiments, the method the computer processor and compressor unit together are operable to conduct may further include predicting the expected injection pressure of the gas necessary to maintain the pressure of the subsurface formation above the subsurface formation dew point pressure, communicating the expected injection pressure of the gas to the compressor unit, and adjusting the injection pressure of the gas into the wellbore to the expected injection pressure.

Alternatively or additionally, the method the computer processor and compressor unit together are operable to conduct may include predicting the expected injection pressure of the gas into the wellbore necessary to suspend and produce the hydrocarbons of the subsurface formation in the wellbore at the predicted condensate liquid dropout, communicating the expected injection pressure of the gas to the compressor unit, and adjusting the injection pressure of the gas into the wellbore to the expected injection pressure.

Having described the subject matter herein in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### Examples

The following examples illustrate features of the present embodiments but are not intended to limit the scope of the same. Particularly, the approach detailed in the Examples infra demonstrate the process used to create and test the predictive model of retrograde condensate liquid dropout versus subsurface formation pressure.

### Normalization of Data Set

A hydrocarbon sample from a retrograde condensate reservoir was first obtained and exposed to a pressure cell at varying pressure depletion points in the laboratory. The LDO was determined at each of these pressure points and mapped as illustrated in FIG. 1A. The pressure and LDO, respectively, were then normalized on a scale of 0 to 1 according to the following equations VIII and II to generate FIG. 1B:

$$L {DO}_{nrm} = \frac{L DO}{L {DO}_{max}} . \qquad ( VIII )$$

### Fitting Normalized Data to Model

The normalized data set was then fit to a hybrid model of Logistic-Hubbert and Bell curves as shown in FIG. 1B with shape controlling parameters P_{nrmPeak}, f_{Hubb}, and f_{Bell}, according to the Equation I.

### Regression of Model's Secondary Parameters

Ideally, the shape controlling parameters of the model should be related to some readily available data to be practically determined and give the best weight. Accordingly, a regression analysis on the shape controlling parameters, P_{nrmPeak}, f_{Bell}, and f_{Hubb}, was conducted with correlation to other fluid physical properties, namely, P_{dew}, Z_{C7+} and T_{R}. The shape controlling parameters were also found to be dependent on the maximum liquid dropout of the hydrocarbons of the subsurface formation.

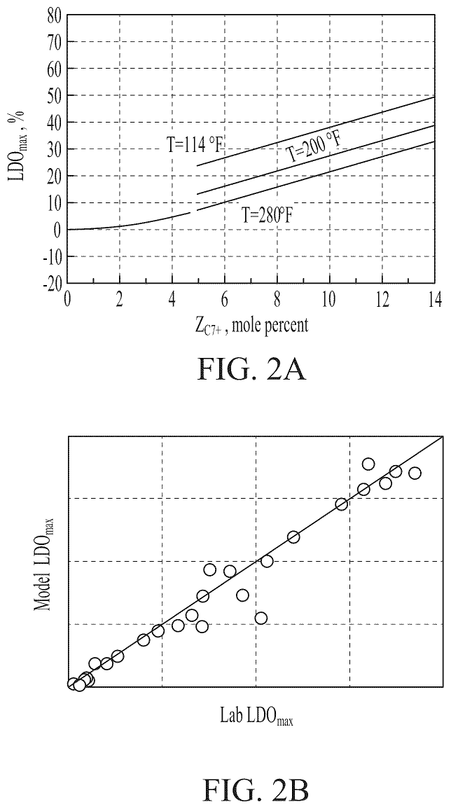

Accordingly, a regression analysis of LDOₘₐₓ dependent on P_{dew}, Z_{C7+} and T_{R} was conducted. The relationship of LDOₘₐₓ to the other fluid properties is shown in FIG. 2A, assuming a P_{dew} of 6000 psi (≈41.37 MPa). As previously described, LDOₘₐₓ was shown to exhibit different behavior below 5 molar percent C₇₊ hydrocarbon fractions than for equal to or greater than 5 molar percent. Accordingly, dual equations were determined for LDOₘₐₓ, equal to Equations II and III respectively. FIG. 2B shows the resultant correlation and good fit between LDOₘₐₓ determined by Equations III and IV as compared to LDOₘₐₓ determined from direct laboratory experiments.

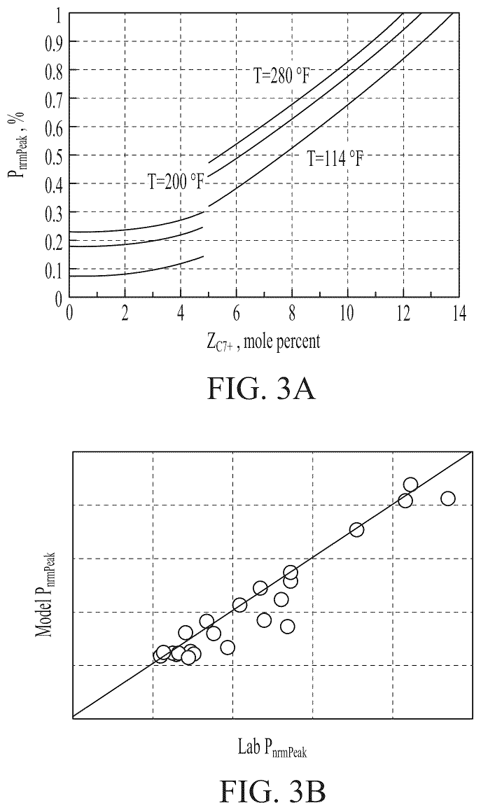

With the dual equations for LDOₘₐₓ determined, regression analysis of the remaining parameters was conducted with the additional input of LDOₘₐₓ based on Equations III and IV. Particularly, the relationship of P_{nrmPeak} to the other fluid properties is shown in FIG. 3A at an assumed P_{dew} of 6000 psi (≈41.37 MPa). Accordingly, an equation was determined for P_{nrmPeak} according to Equation VII. FIG. 3B shows the resultant correlation and good fit between P_{nrmPeak} determined by Equation VII as compared to P_{nrmPeak} determined from direct regression of lab data.

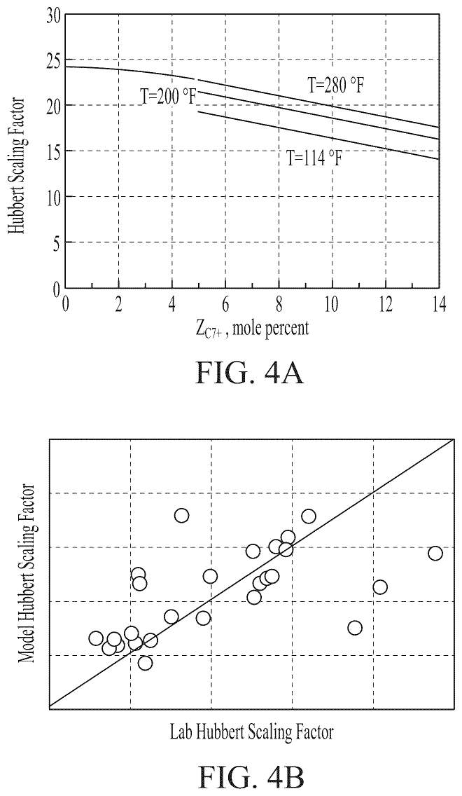

Similarly to the P_{nrmPeak}, regression analysis of f_{Hubb} was conducted with the additional input of LDOₘₐₓ based on Equations II and III. Particularly, the relationship of f_{Hubb} to the other fluid properties is shown in FIG. 4A at an assumed P_{dew} of 6000 psi (≈41.37 MPa). Accordingly, an equation was determined for f_{Hubb} according to Equation V. As previously described, f_{Hubb} controls the predicted LDO curve's tail. FIG. 4B shows the resultant correlation and reasonable fit between f_{Hubb} determined by Equation V as compared to f_{Hubb} determined from direct regression of lab data.

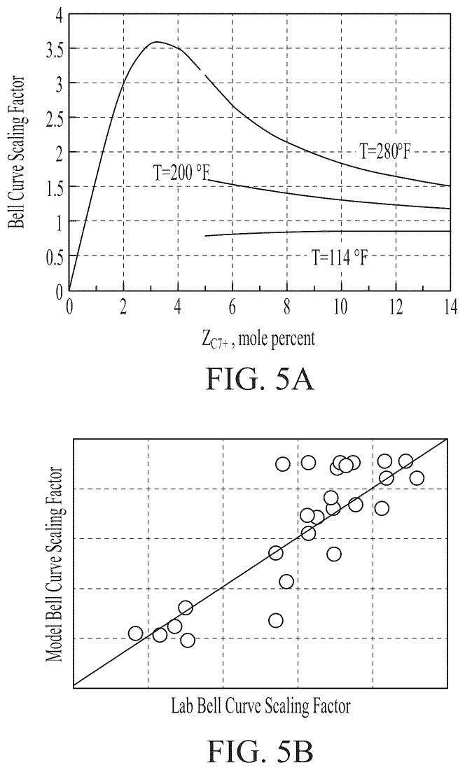

Similarly to the Pₙᵣₘmax and f_{Hubb}, regression analysis of f_{Bell} was conducted with the additional input of LDOₘₐₓ based on Equations II and III. Particularly, the relationship of f_{Bell} to the other fluid properties is shown in FIG. 5A at an assumed P_{dew} of 6000 psi (≈41.37 MPa). Accordingly, an equation of state was determined for f_{Bell} according to Equation IV. As previously described, f_{Bell} controlled the predicted LDO curve's width and plateau. FIG. 5B shows the resultant correlation and good fit between f_{Bell} determined by Equation IV as compared to f_{Bell} determined from direct regression of lab data.

### De-Normalization of Model and Blind Testing

With the regression of the secondary parameters complete, Equation I governing the model was then de-normalized using Equations II and VIII to form equivalent Equations IX and X with formulas:

$$L DO = L {{DO}_{max} ( {( {Z}_{C 7 +} * {e}^{\frac{{f}_{H u b b} * {P}_{R}}{{P}_{d e w}}} )}^{- 7} + 1 )}^{- 1} * ( {e}^{- 1 * {f}_{Bell} * {( \frac{P}{{P}_{dew}} - {P}_{max} )}^{2}} ) ; \qquad ( IX )$$

$$L DO = L {DO}_{max} * \frac{{( {Z}_{C 7 +} * {e}^{\frac{{f}_{Hubb} * {P}_{R}}{{P}_{dew}}} )}^{- 7} + 1}{{e}^{- 1 * {f}_{Bell} * {( \frac{P}{{P}_{dew}} - {P}_{max} )}^{2}}} . \qquad ( X )$$

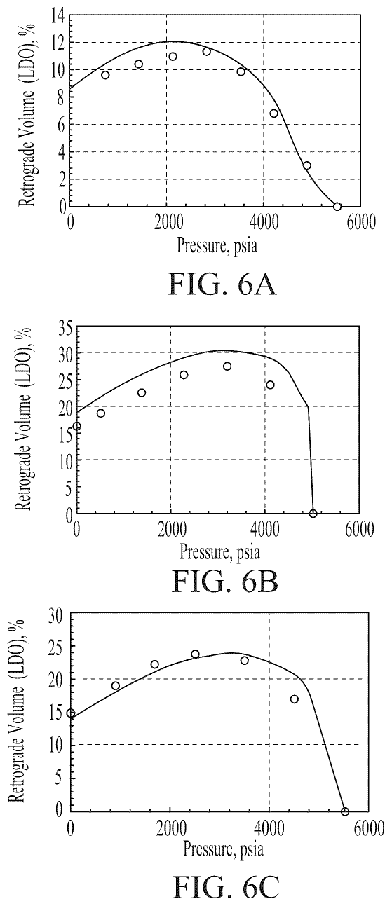

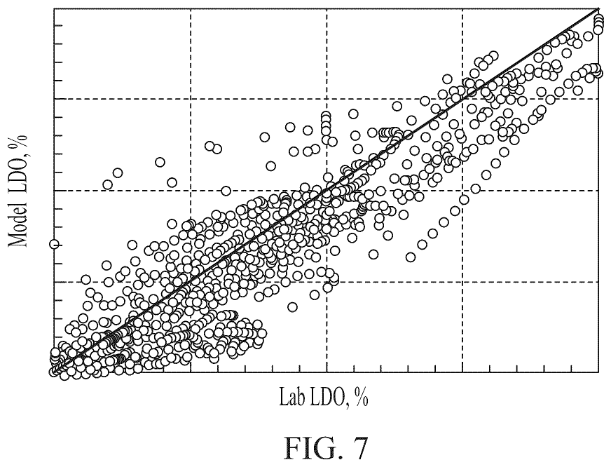

The de-normalized model was subsequently blind tested against publicly available retrograde condensate data sets, particularly those from Pederson et. al, Ahmed, and Retrograde Gas PVT Fluid Study, to determine the correlation between model predicted LDO and data set LDO. Pedersen, Karen & Christensen, Peter & Azeem, Jawad. (2014). Phase Behavior of Petroleum Reservoir Fluids; Ahmed, Tareq. (2016). Equations of State and PVT Analysis: Applications for Improved Reservoir Modeling: Second Edition, Gulf Publications; and Retrograde Gas PVT Fluid Study (2008), FESCO. Ltd. The blind testing is shown in FIGS. 6A-6C for Pederson, Ahmed, and Public PVT report, respectively. Moreover, the model was also tested on a large data set of 170 samples obtained from various gas condensate reservoirs and the results are shown in FIG. 7 with a coefficient of determination (R²) of 0.8816.

At this point the model demonstrated an ability to reliably predict liquid drop out of retrograde liquid condensate along the entire range of subsurface formation pressures, retrograde condensate gas reservoirs.

It is also noted that recitations herein of “at least one” component, element, etc., should not be used to create an inference that the alternative use of the articles “a” or “an” should be limited to a single component, element, etc.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A process for addressing retrograde liquid condensate dropout (LDO) in a subsurface formation comprising hydrocarbons at least by adjusting an injection pressure of a gas into a wellbore, the process comprising:
determining a maximum retrograde condensate liquid dropout (LDOₘₐₓ) for the subsurface formation, the LDOₘₐₓ being a function of a subsurface formation pressure (T_{R}), a subsurface formation dew point pressure (P_{dew}), a mole percentage of C₇₊ hydrocarbons (Z_{C7+}) within the hydrocarbons of the subsurface formation, or combinations thereof,
generating a normalized model of retrograde condensate liquid dropout versus subsurface formation pressure according to an equation with formula:
$$L {DO}_{nrm} = L {DO}_{max} * \frac{( {e}^{( - 1 * {f}_{Bell} * {( {P}_{nrm} - {P}_{nrmPeak} )}^{2} )} )}{( 1 {0}^{- 7} * {Z}_{C 7 +} * {e}^{{f}_{H u b b} * {P}_{n r m}} ) + 1} ,$$
where e denotes the exponential constant, f_{Hubb} denotes a Hubbert curve scaling factor, f_{Bell} denotes a bell curve scaling factor, P_{nrmPeak} denotes a normalized pressure of the subsurface formation at which LDOₘₐₓ occurs, and P_{R} denotes the observed pressure of the subsurface formation,
inputting a normalized pressure (Pₙᵣₘ) into the model based on the pressure of the subsurface formation, and according to the formula:
$${P}_{nrm} = \frac{{P}_{R}}{{P}_{d e w}} ,$$
thereby predicting a normalized predicted condensate liquid dropout (LDOₙᵣₘ) within the subsurface formation,
de-normalizing the LDOₙᵣₘ according to the formula: LDO=LDOₙᵣₘ*LDOₘₐₓ, thereby generating a predicted condensate liquid dropout within the subsurface formation,
predicting (i) an expected injection pressure of the gas necessary to maintain the pressure of the subsurface formation above the subsurface formation dew point pressure or (ii) an expected injection pressure of the gas into the wellbore necessary to suspend and produce liquid condensate of the hydrocarbons of the subsurface formation in the wellbore, at the predicted condensate liquid dropout,
communicating the expected injection pressure to a compressor unit, the compressor unit configured to inject the gas at the injection pressure into the wellbore of the subsurface formation, and
adjusting the injection pressure of the gas into the wellbore at the compressor unit to the expected injection pressure to address the retrograde liquid condensate dropout in the subsurface formation.

2. The process of claim 1, wherein the gas comprises nitrogen, carbon dioxide, a hydrocarbon gas, or combinations thereof.

3. The process of claim 1, wherein:
Z_{C7+} is less than 5 mole percent;
LDOₘₐₓ is determined according to an equation with formula:
$$L {DO}_{max} = {x}_{1} * {( {Z}_{C 7 +} )}^{{x}_{2}} ;$$
x₁ denotes a constant of from 0.15 to 0.45; and
x₂ denotes a constant of from 1.8 to 2.1.

4. The process of claim 1, wherein:
Z_{C7+} is greater than or equal to 5 mole percent and
LDOₘₐₓ is determined according to an equation with formula:
$${LDO}_{max} = {x}_{3} - ( {x}_{4} * \frac{Ln ( {P}_{dew} )}{{e}^{{Z}_{C 7 +}}} ) - ( {x}_{5} * Ln ( {T}_{R} ) ) ;$$
Ln denotes the natural logarithm;
x₃ denotes a constant of from 410 to 560;
x₄ denotes a constant of from 35 to 45; and
x₅ denotes a constant of from 18 to 30.

5. The process of claim 1, wherein the bell curve scaling factor is determined according to an equation with formula:
$${f}_{Bell} = {Z}_{C 7 +} * \frac{{x}_{6}}{{x}_{7} + {( {LDO}_{max} )}^{{x}_{8}}} ,$$
$$wherein :$$
x₆ denotes a constant of from 10 to 20;
x₇ denotes a constant of from 5 to 20; and
x₈ denotes a constant of from 1.1 to 1.7.

6. The process of claim 1, wherein the Hubbert curve scaling factor is determined according to an equation with formula:
$${f}_{Hubb} = ( {x}_{9} * {LDO}_{max} ) + {x}_{10} ,$$
$$wherein :$$
x₉ denotes a constant of from 0.15 to 0.25; and
x₁₀ denotes a constant of from 22 to 26.

7. The process of claim 1, wherein P_{nrmPeak} is determined according to an equation with formula:
$${P}_{nrmPeak} = {x}_{11} + ( {x}_{12} * {( {Z}_{C 7 +} )}^{{x}_{13}} * {( {LDO}_{max} )}^{{x}_{14}} * {( \frac{1}{Ln ( {P}_{dew} )} )}^{{x}_{15}} ) - ( {x}_{16} * {( \frac{1}{Ln ( {T}_{R} )} )}^{{x}_{17}} ) ,$$
Ln denotes the natural logarithm;
x₁₁ denotes a constant of from 1 to 1.4;
x₁₂ denotes a constant of from 0.002 to 0.008;
x₁₃ denotes a constant of from 0.3 to 0.9;
x₁₄ denotes a constant of from 0.7 to 1.2;
x₁₅ denotes a constant of from 0.05 to 0.2;
x₁₆ denotes a constant of from 4 to 4.5; and
x₁₇ denotes a constant of from 0.8 to 1.

8. The process of claim 1, wherein:
if Z_{C7+} is less than 5 mole percent, LDOₘₐₓ is determined according to an equation with formula:
$${LDO}_{max} = {x}_{1} * {( {Z}_{C 7 +} )}^{{x}_{2}} ,$$
else LDOₘₐₓ is determined according to an equation with formula:
$${LDO}_{max} = {x}_{3} - ( {x}_{4} * \frac{Ln ( {P}_{dew} )}{{e}^{{Z}_{C 7 +}}} ) - ( {x}_{5} * Ln ( {T}_{R} ) ) ;$$
the bell curve scaling factor is determined according to an equation with formula:
$${f}_{Bell} = {Z}_{C 7 +} * \frac{{x}_{6}}{{x}_{7} + {( {LDO}_{max} )}^{{x}_{8}}} ;$$
the Hubbert curve scaling factor is determined according to an equation with formula:
$${f}_{Hubb} = ( {x}_{9} * {LDO}_{max} ) + {x}_{10} ;$$
the P_{nrmPeak} is determined according to an equation with formula:
$${P}_{nrmPeak} = {x}_{11} + ( {x}_{12} * {( {Z}_{C 7 +} )}^{{x}_{13}} * {( {LDO}_{max} )}^{{x}_{14}} * {( \frac{1}{Ln ( {P}_{dew} )} )}^{{x}_{15}} ) - ( {x}_{16} * {( \frac{1}{Ln ( {T}_{R} )} )}^{{x}_{17}} ) ;$$
and
wherein:
Ln denotes the natural logarithm, and
x₁ through x₁₇, respectively, denote constants equal to from 0.15 to 0.45, from 1.8 to 2.1, from 410 to 560, from 35 to 45, from 18 to 30, from 10 to 20, from 5 to 20, from 1.1 to 1.7, from 0.15 to 0.25, from 22 to 26, from 1 to 1.4, from 0.002 to 0.008, from 0.3 to 0.9; from 0.7 to 1.2; from 0.05 to 0.2; from 4 to 4.5; and from 0.8 to 1.

9. The process of claim 1, wherein:
the dew point pressure is determined utilizing laboratory optical detection devices;
the mole percentage of C₇₊ hydrocarbon fractions (Z_{C7+}) within the hydrocarbons of the subsurface formation is determined by analyzing a sample of the hydrocarbons of the subsurface formation using gas chromatography-mass spectrometry;
the subsurface formation temperature is determined from direct measurement using downhole temperature gauges; or
combinations thereof.

10. The process of claim 1, further comprising:
observing a decrease in the pressure of the subsurface formation;
inputting a second normalized pressure (Pₙᵣₘ) into the model based on the pressure of the subsurface formation, thereby generating a second normalized predicted condensate liquid dropout (second LDOₙᵣₘ) within the subsurface formation;
de-normalizing the second LDOₙₒᵣₘ according to the formula: LDO=LDOₙₒᵣₘ*LDOₘₐₓ, thereby generating a second predicted condensate liquid dropout within the subsurface formation;
predicting (i) a second expected injection pressure of the gas necessary to maintain the pressure of the subsurface formation above the subsurface formation dew point pressure or (ii) a second expected injection pressure of the gas into the wellbore necessary to suspend and produce liquid condensate of the hydrocarbons of the subsurface formation in the wellbore at the second predicted condensate liquid dropout,
communicating the second expected injection pressure to the compressor unit, and
adjusting the injection pressure of the gas into the wellbore at the compressor unit to the second expected injection pressure to address the retrograde liquid condensate dropout in the subsurface formation.

11. A process for addressing retrograde liquid condensate dropout (LDO) in a subsurface formation comprising hydrocarbons at least by injecting a liquid condensate dissolving solution into a wellbore, the process comprising:
determining a maximum retrograde condensate liquid dropout (LDOₘₐₓ) for the subsurface formation, the LDOₘₐₓ being a function of a subsurface formation pressure (T_{R}), a subsurface formation dew point pressure (P_{dew}), a mole percentage of C₇₊ hydrocarbons (Z_{C7+}) within the hydrocarbons of the subsurface formation, or combinations thereof;
generating a normalized model of retrograde condensate liquid dropout versus subsurface formation pressure according to an equation with formula:
$${LDO}_{nrm} = {LDO}_{max} * \frac{( {e}^{( - 1 * {f}_{Bell} * {( {P}_{nrm} - {P}_{nrmPeak} )}^{2} )} )}{( {10}^{- 7} * {Z}_{C 7 +} {e}^{{f}_{Hubb} * {P}_{nrm}} ) + 1} ,$$
where e denotes the exponential constant, f_{Hubb} denotes a Hubbert curve scaling factor, f_{Bell} denotes a bell curve scaling factor, P_{nrmPeak} denotes a normalized pressure of the subsurface formation at which LDOₘₐₓ occurs, and P_{R} denotes the observed pressure of the subsurface formation;
inputting a normalized pressure (Pₙᵣₘ) into the model based on the pressure of the subsurface formation, and according to the formula:
$${P}_{nrm} = \frac{{P}_{R}}{{P}_{dew}} ,$$
thereby predicting a normalized predicted condensate liquid dropout (LDOₙᵣₘ) within the subsurface formation;
de-normalizing the LDOₙᵣₘ according to the formula: LDO=LDOₙᵣₘ*LDOₘₐₓ, thereby generating a predicted condensate liquid dropout within the subsurface formation;
predicting (i) an expected amount of the liquid condensate dissolving solution necessary to dissolve liquid condensate of the hydrocarbons of the subsurface formation at the predicted condensate liquid dropout or (ii) an expected injection rate of the liquid condensate dissolving solution necessary to dissolve the liquid condensate of the hydrocarbons of the subsurface formation at the predicted condensate liquid dropout;
communicating the expected amount of the liquid condensate dissolving solution or the expected injection rate of the liquid condensate dissolving solution to a pump, the pump configured to inject the liquid condensate dissolving solution into the wellbore of the subsurface formation; and
injecting the expected amount of the liquid condensate dissolving solution or the expected injection rate of the liquid condensate dissolving solution into the wellbore of the subsurface formation to address retrograde liquid condensate dropout (LDO) in the subsurface formation.

12. The process of claim 11, wherein:
if Z_{C7+} is less than 5 mole percent, LDOₘₐₓ is determined according to an equation with formula:
$${LDO}_{max} = {x}_{1} * {( {Z}_{C 7 +} )}^{{x}_{2}} ,$$
else LDOₘₐₓ is determined according to an equation with formula:
$${LDO}_{max} = {x}_{3} - ( {x}_{4} * \frac{Ln ( {P}_{dew} )}{{e}^{{Z}_{C 7 +}}} ) - ( {x}_{5} * Ln ( {T}_{R} ) ) ;$$
the bell curve scaling factor is determined according to an equation with formula:
$${f}_{Bell} = {Z}_{C 7 +} * \frac{{x}_{6}}{{x}_{7} + {( {LDO}_{max} )}^{{x}_{8}}} ;$$
the Hubbert curve scaling factor is determined according to an equation with formula:
$${f}_{Hubb} = ( {x}_{9} * {LDO}_{max} ) + {x}_{10} ;$$
the P_{nrmPeak} is determined according to an equation with formula:
$${P}_{nrmPeak} = {x}_{11} + ( {x}_{12} * {( {Z}_{C 7 +} )}^{{x}_{13}} * {( {LDO}_{max} )}^{{x}_{14}} * {( \frac{1}{Ln ( {P}_{dew} )} )}^{{x}_{15}} ) - ( {x}_{16} * {( \frac{1}{Ln ( {T}_{R} )} )}^{{x}_{17}} ) ;$$
and
wherein:
Ln denotes the natural logarithm, and
x₁ through x₁₇, respectively, denote constants equal to from 0.15 to 0.45, from 1.8 to 2.1, from 410 to 560, from 35 to 45, from 18 to 30, from 10 to 20, from 5 to 20, from 1.1 to 1.7, from 0.15 to 0.25, from 22 to 26, from 1 to 1.4, from 0.002 to 0.008, from 0.3 to 0.9; from 0.7 to 1.2; from 0.05 to 0.2; from 4 to 4.5; and from 0.8 to 1.

13. The process of claim 11, wherein the liquid condensate dissolving solution comprises methanol, supercritical water, steam, carbon dioxide, supercritical carbon dioxide, or combinations thereof.

14. The process of claim 11, further comprising:
observing a decrease in the pressure of the subsurface formation;
inputting a second normalized pressure (Pₙᵣₘ) into the model based on the pressure of the subsurface formation, thereby generating a second normalized predicted condensate liquid dropout (second LDOₙᵣₘ) within the subsurface formation;
de-normalizing the second LDOₙₒᵣₘ according to the formula: LDO=LDOₙₒᵣₘ*LDOₘₐₓ, thereby generating a second predicted condensate liquid dropout within the subsurface formation;
predicting (i) a second expected amount of the liquid condensate dissolving solution necessary to dissolve the liquid condensate of the hydrocarbons of the subsurface formation at the second predicted condensate liquid dropout or (ii) a second expected injection rate of the liquid condensate dissolving solution necessary to dissolve the liquid condensate of the hydrocarbons of the subsurface formation at the second predicted condensate liquid dropout;
communicating the second expected amount of the liquid condensate dissolving solution or the second expected injection rate of the liquid condensate dissolving solution to the pump; and
injecting the second expected amount of the liquid condensate dissolving solution or the second expected injection rate of the liquid condensate dissolving solution into the wellbore of the subsurface formation to address retrograde liquid condensate dropout (LDO) in the subsurface formation.

15. A system for addressing retrograde liquid condensate dropout (LDO) in a subsurface formation comprising hydrocarbons, the system comprising:
a compressor unit configured to inject a gas at an injection pressure into the wellbore of the subsurface formation; and
a computer processor communicatively coupled to the compressor unit and operable to execute a method with the compressor unit, the method comprising:
determining a maximum retrograde condensate liquid dropout (LDOₘₐₓ) for the subsurface formation, the LDOₘₐₓ being a function of a subsurface formation pressure (T_{R}), a subsurface formation dew point pressure (P_{dew}), a mole percentage of C₇₊ hydrocarbons (Z_{C7+}) within the hydrocarbons of the subsurface formation, or combinations thereof,
generating a normalized model of retrograde condensate liquid dropout versus subsurface formation pressure according to an equation with formula:
$${LDO}_{nrm} = {LDO}_{max} * \frac{( {e}^{( - 1 * {f}_{Bell} * {( {P}_{nrm} - {P}_{nrmPeak} )}^{2} )} )}{( 1 {0}^{- 7} * {Z}_{C 7 +} * {e}^{{f}_{Hubb} * {P}_{nrm}} ) + 1} ,$$
where e denotes the exponential constant, f_{Hubb} denotes a Hubbert curve scaling factor, f_{Bell} denotes a bell curve scaling factor, P_{nrmPeak} denotes a normalized pressure of the subsurface formation at which LDOₘₐₓ occurs, and
P_{R} denotes the observed pressure of the subsurface formation,
inputting a normalized pressure (Pₙᵣₘ) into the model based on the pressure of the subsurface formation, and according to the formula:
$${P}_{nrm} = \frac{{P}_{R}}{{P}_{dew}} ,$$
thereby predicting a normalized predicted condensate liquid dropout (LDOₙᵣₘ) within the subsurface formation,
de-normalizing the LDOₙᵣₘ according to the formula: LDO=LDOₙᵣₘ*LDOₘₐₓ, thereby generating a predicted condensate liquid dropout within the subsurface formation,
predicting (i) an expected injection pressure of the gas necessary to maintain the pressure of the subsurface formation above the subsurface formation dew point pressure or (ii) an expected injection pressure of the gas into the wellbore necessary to suspend and produce liquid condensate of the hydrocarbons of the subsurface formation in the wellbore, at the predicted condensate liquid dropout,
communicating the expected injection pressure to the compressor unit, and
adjusting the injection pressure of the gas into the wellbore to the expected injection pressure to address the retrograde liquid condensate dropout in the subsurface formation.

16. The system of claim 15, wherein the gas comprises carbon dioxide, a hydrocarbon gas, or combinations thereof.

17. The system of claim 15, wherein:
if Z_{C7+} is less than 5 mole percent, LDOₘₐₓ is determined according to an equation with formula:
$${LDO}_{max} = {x}_{1} * {( {Z}_{C 7 +} )}^{{x}_{2}} ,$$
else LDOₘₐₓ is determined according to an equation with formula:
$${LDO}_{max} = {x}_{3} - ( {x}_{4} * \frac{Ln ( {P}_{dew} )}{{e}^{{Z}_{C 7 +}}} ) - ( {x}_{5} * Ln ( {T}_{R} ) ) ;$$
the bell curve scaling factor is determined according to an equation with formula:
$${f}_{Bell} = {Z}_{C 7 +} * \frac{{x}_{6}}{{x}_{7} + {( {LDO}_{max} )}^{{x}_{8}}} ;$$
the Hubbert curve scaling factor is determined according to an equation with formula:
$${f}_{Hubb} = ( {x}_{9} * {LDO}_{max} ) + {x}_{10} ;$$
the P_{nrmPeak} is determined according to an equation with formula:
$${P}_{nrmPeak} = {x}_{11} + ( {x}_{12} * {( {Z}_{C 7 +} )}^{{x}_{13}} * {( {LDO}_{max} )}^{{x}_{14}} * {( \frac{1}{Ln ( {P}_{dew} )} )}^{{x}_{15}} ) - ( {x}_{16} * {( \frac{1}{Ln ( {T}_{R} )} )}^{{x}_{17}} ) ;$$
Ln denotes the natural logarithim; and
x₁ through x₁₇, respectively, denote constants equal to from 0.15 to 0.45, from 1.8 to 2.1, from 410 to 560, from 35 to 45, from 18 to 30, from 10 to 20, from 5 to 20, from 1.1 to 1.7, from 0.15 to 0.25, from 22 to 26, from 1 to 1.4, from 0.002 to 0.008, from 0.3 to 0.9; from 0.7 to 1.2; from 0.05 to 0.2; from 4 to 4.5; and from 0.8 to 1.

18. A system for addressing retrograde liquid condensate dropout (LDO) in a subsurface formation comprising hydrocarbons, the system comprising:
a pump configured to inject a liquid condensate dissolving solution into a wellbore of the subsurface formation; and
a computer processor communicatively coupled to the pump and operable to execute a method with the pump, the method comprising:
determining a maximum retrograde condensate liquid dropout (LDOₘₐₓ) for the subsurface formation, the LDOₘₐₓ being a function of a subsurface formation pressure (T_{R}), a subsurface formation dew point pressure (P_{dew}), a mole percentage of C₇₊ hydrocarbons (Z_{C7+}) within the hydrocarbons of the subsurface formation, or combinations thereof,
generating a normalized model of retrograde condensate liquid dropout versus subsurface formation pressure according to an equation with formula:
$${LDO}_{nrm} = {LDO}_{max} * \frac{( {e}^{( - 1 * {f}_{Bell} * {( {P}_{nrm} - {P}_{nrmPeak} )}^{2} )} )}{( 1 {0}^{- 7} * {Z}_{C 7 +} * {e}^{{f}_{Hubb} * {P}_{nrm}} ) + 1} ,$$
where e denotes the exponential constant, f_{Hubb} denotes a Hubbert curve scaling factor, f_{Bell} denotes a bell curve scaling factor, P_{nrmPeak} denotes a normalized pressure of the subsurface formation at which LDOₘₐₓ occurs, and
P_{R} denotes the observed pressure of the subsurface formation,
inputting a normalized pressure (Pₙᵣₘ) into the model based on the pressure of the subsurface formation, and according to the formula:
$${P}_{nrm} = \frac{{P}_{R}}{{P}_{dew}} ,$$
thereby predicting a normalized predicted condensate liquid dropout (LDOₙᵣₘ) within the subsurface formation,
de-normalizing the LDOₙᵣₘ according to the formula: LDO=LDOₙᵣₘ*LDOₘₐₓ, thereby generating a predicted condensate liquid dropout within the subsurface formation,
predicting (i) an expected amount of the liquid condensate dissolving solution necessary to dissolve liquid condensate of the hydrocarbons of the subsurface formation at the predicted condensate liquid dropout or (ii) an expected injection rate of the liquid condensate dissolving solution necessary to dissolve the liquid condensate of the hydrocarbons of the subsurface formation at the predicted condensate liquid dropout,
communicating the expected amount of liquid condensate dissolving solution or the expected injection rate of liquid condensate dissolving solution to the pump, and
injecting the expected amount of the liquid condensate dissolving solution or the expected injection rate of the liquid condensate dissolving solution into the wellbore of the subsurface formation to address the retrograde liquid condensate dropout in the subsurface formation.

19. The system of claim 18, wherein the liquid condensate dissolving solution comprises methanol, supercritical water, steam, carbon dioxide, supercritical carbon dioxide, or combinations thereof.

20. The system of claim 18, wherein:
if Z_{C7+} is less than 5 mole percent, LDOₘₐₓ is determined according to an equation with formula:
$${LDO}_{max} = {x}_{1} * {( {Z}_{C 7 +} )}^{{x}_{2}} ,$$
else LDOₘₐₓ is determined according to an equation with formula:
$${LDO}_{max} = {x}_{3} - ( {x}_{4} * \frac{Ln ( {P}_{dew} )}{{e}^{{Z}_{C 7 +}}} ) - ( {x}_{5} * Ln ( {T}_{R} ) ) ;$$
the bell curve scaling factor is determined according to an equation with formula:
$${f}_{Bell} = {Z}_{C 7 +} * \frac{{x}_{6}}{{x}_{7} + {( {LDO}_{max} )}^{{x}_{8}}} ;$$
the Hubbert curve scaling factor is determined according to an equation with formula:
$${f}_{Hubb} = ( {x}_{9} * {LDO}_{max} ) + {x}_{10} ;$$
the P_{nrmPeak} is determined according to an equation with formula:
$${P}_{nrmPeak} = {x}_{11} + ( {x}_{12} * {( {Z}_{C 7 +} )}^{{x}_{13}} * {( {LDO}_{max} )}^{{x}_{14}} * {( \frac{1}{Ln ( {P}_{dew} )} )}^{{x}_{15}} ) - ( {x}_{16} * {( \frac{1}{Ln ( {T}_{R} )} )}^{{x}_{17}} ) ;$$
Ln denotes the natural logarithim; and
